(19) United States
(12) Patent Application Publication
(10) Pub. No.: US 2015/0052520 A1
(43) Pub. Date: Feb. 19, 2015

(54) METHOD AND APPARATUS FOR VIRTUAL MACHINE TRUST ISOLATION IN A CLOUD ENVIRONMENT

(71) Applicant: International Business Machines Corporation, Armonk, NY (US)

(72) Inventors: Susan F. CROWELL, Rochester, MN (US); Jason A. NIKOLAI, Rochester, MN (US); Andrew T. THORSTENSEN, Rochester, MN (US)

(73) Assignee: International Business Machines Corporation, Armonk, NY (US)

(21) Appl. No.: 14/057,321

(22) Filed: Oct. 18, 2013

Related U.S. Application Data
(63) Continuation of application No. 13/969,705, filed on Aug. 19, 2013.

(51) Int. Cl. G06F 21/53

(52) U.S. Cl. CPC G06F 21/53
USPC 718/1

(57) ABSTRACT

Techniques are disclosed for virtual machine trust isolation in an Infrastructure-as-a-Service (IaaS) cloud environment. More specifically, embodiments of the invention monitor levels of suspicious activity on a particular virtual machine using node agents embedded in each physical node. The node agents transmit activity data to a security and relocation engine. If a virtual machine's suspicious activity levels exceed defined suspicious activity thresholds, the security and relocation engine assigns that virtual machine to a different zone. The zones may have reduced connectivity and/or service levels. This enables administrators to more efficiently respond to security threats in the cloud environment.

### CROSS-REFERENCE TO RELATED APPLICATIONS

This application is a continuation of co-pending U.S. patent application Ser. No. 13/969,705, filed Aug. 19, 2013. The aforementioned related patent application is herein incorporated by reference in its entirety.

### BACKGROUND

Embodiments of the invention generally relate to virtual machine security in a hosted or cloud environment. More specifically, techniques are disclosed for determining when a virtual machine may be compromised and for relocating the virtual machine to separate zones for investigation.

In many Infrastructure-as-a-Service (IaaS) cloud computing environments, cloud customers can provide their own virtual machine images for deployment into a cloud service provider's environment. When deployed, the virtual machine image runs on physical hardware in a multi-tenant environment, i.e. an environment of multiple physical host machines where each physical host may house one or more virtual machines. The cloud service provider determines the placement of each virtual machine. That is, the cloud service provider selects a host on which to launch the virtual machine image.

### SUMMARY

Embodiments presented herein include a method of enforcing virtual machine trust isolation in a cloud environment. This method may generally include receiving activity data generated from monitoring a virtual machine with a zone assignment of a trusted zone in the cloud environment and determining, from the activity data, a measure of suspicious activity engaged in by the virtual machine. This method may also include reassigning the zone assignment of the virtual machine if the measure of suspicious activity exceeds a at least a first threshold.

In a particular embodiment, reassigning the zone assignment of the virtual machine may include relocating the virtual machine from a first host server to a second host server.

For example, if the measure of suspicious activity exceeds a first threshold, then the virtual machine may be relocated to an un-trusted zone. While in the un-trusted zone, the virtual machine may be subject to additional scrutiny, such as additional logging or monitoring. If the measure of suspicious activity exceeds a second threshold, then the virtual machine may be relocated to a disabled trusted zone. While in the disabled zone, the virtual machine may be suspended from operating and snapshots of the virtual machine state may be captured.

One advantage of this method is that the method enables a cloud security administrator to track suspicious activity events on virtual machines in real time rather than afterward, and enables the administrator to relocate any affected virtual machines to separate them from healthy virtual machines, therefore preventing further security breaches. By relocating affected virtual machines, the method also prevents healthy virtual machines from suffering slower performance.

### BRIEF DESCRIPTION OF THE SEVERAL VIEWS OF THE DRAWINGS

So that the manner in which the above recited aspects are attained and can be understood in detail, a more particular description of embodiments of the invention, briefly summarized above, may be had by reference to the appended drawings.

It is to be noted, however, that the appended drawings illustrate only typical embodiments of this invention and are therefore not to be considered limiting of its scope, for the invention may admit to other equally effective embodiments.

FIG. 1 illustrates a collection of hosts separated into security zones managed by a security and relation engine, according to one embodiment.

FIG. 2 illustrates an example cloud environment, according to one embodiment.

FIG. 3 illustrates a security and relocation engine, according to one embodiment.

FIG. 4 illustrates a method for determining whether a virtual machine is exhibiting specific levels of suspicious activity, and relocating that machine appropriately, according to one embodiment.

FIG. 5 illustrates an example virtual machine system, according to one embodiment.

### DETAILED DESCRIPTION

In contrast to traditional networks, cloud computing networks face internal as well as external security threats. In some cases, what overtly appears to be a legitimate actor may nevertheless compromise security. For example, malicious actors have found ways to manipulate collocation algorithms to have a virtual machine launched on a desired physical node. Such physical nodes may house other virtual machines that are targeted in an attempt to extract sensitive data. For example, once collocated, a malicious actor might attempt to access a CPU cache, retrieve data or otherwise retrieve encryption keys. A malicious user could also perpetrate attacks such as an apparent distributed denial of service from a target machine, such that the target machine's end-users interpret this as system failure and switch to the targeted machine owner's competitors in the market. Further, aside from any intentional wrongdoing, a mis-configured virtual machine can damage to other virtual machines on that same host—or on neighboring hosts—within the cloud computing environment.

Currently, network technicians use static, discrete processes to manually monitor and respond to such malicious activity. Since the technician response is reactive, malicious actors are able to do more damage than if caught in the act. A static response makes it difficult to apprehend such actors. A malicious user may create a virtual machine, quickly collocate the virtual machine near another desired virtual machine, extract critical data, and then shut down the malicious user's own virtual machine leaving no trace. A user may request and pay for a virtual machine in the cloud legitimately, only to create and destroy a large number of virtual machines in a short time to collocate with a target virtual machine, once the user gains access to the cloud. Even if the user fails to compromise cloud security, the user's actions nevertheless strain cloud resources (CPU, I/O, bandwidth) resulting in diminished service levels. Especially in smaller cloud environments, administrators lack the capacity to detect and respond to such attacks with the appropriate speed.

Embodiments presented herein provide techniques for identifying suspicious activity on virtual machines within an IaaS public or private or public-private hybrid cloud network. Once identified, embodiments presented herein also provide techniques for separating virtual machines observed to engage in suspicious behavior from other virtual machines in a cluster. In one embodiment, virtual machine data, virtual machine migration techniques, and forensic lockout and investigation schemes provide a real-time cloud security process. A cloud administrator may define what activity should be evaluated, how much suspicious activity is permissible on a virtual machine before relocating that virtual machine, thresholds used to trigger relocation, and what zones are available to relocate a given virtual machine.

For example, a physical host, or node, may host multiple virtual machines. In one embodiment, the physical node may run an agent that records different types of activity that the hosted virtual machines engage in or experience. The node agent may provide this data to a security and relocation engine outside the physical node. The security and relocation engine may determine whether the observed suspicious activity exceeds specific thresholds and if so, notify the administrator that the virtual machine should be relocated (or simply relocate the virtual machine). Over time, the security and relocation engine learns to automatically make relocation decisions, without administrator intervention.

In one embodiment, a cloud network provides a collection of physical servers, or nodes, connected via a cloud management platform. Each node executes a hypervisor, which is computer software that creates, launches, and runs virtual machines. More specifically, the hypervisor exposes a virtualized computing instance, e.g., a virtualized processor, memory, etc., to guest operating systems. Each node may run multiple virtual machines, such that each virtual machine shares the underlying physical hardware, CPU, CPU cache, and I/O resources. The hypervisor on each node may include a node agent. Alternatively, the node agent may reside in other devices within the infrastructure (such as switches or appliances). In one embodiment, the node agent records instances of suspicious activity. The node agent communicates with a security and relocation engine that evaluates whether a particular virtual machine's suspicious activity levels exceed specific thresholds.

For example, suspicious activities may include:
A single user creating and destroying many virtual machines in a short time (trying to get the placement engine to locate the virtual machine on a particular node)
Extreme resource utilization (CPU, IO, Network, etc.) that violates the terms agreed upon for cloud usage
Detection of unapproved tools (Sniffer tools, network card put into promiscuous mode, nmap/port scans, manipulated frames, etc)
Any other activity that can be detected from outside of the virtual machine

Further, the administrator may define what types of activity to record, and the method and frequency of recording. In yet another embodiment, the cloud administrator may customize a variety of variables e.g., the frequency and method of transmission between the node agent(s) and the security and relocation engine. In other embodiments, a secondary node agent may also reside within the virtual machine to gather data.

In one embodiment, the administrator creates a set of zones within the cloud network based on defined criteria. As a reference example, embodiments are described herein using three zones: a trusted zone, an un-trusted zone, and a disabled zone. Of course, one of skill in the art will recognize that a cloud administrator may define any number of zones customized to the particular cloud network. In the reference example herein, the trusted zone includes virtual machines determined to be in a healthy state with a low amount or no amount of suspicious activity. Virtual machines in the trusted zone operate under default or normal service levels (e.g. bandwidth, resource allocation) as well as default or normal administrator monitoring levels.

The un-trusted zone includes virtual machines observed to exhibit suspicious behavior exceeding a certain threshold. In one embodiment, virtual machines in the un-trusted zone may continue to run and be connected to other systems in the data center (and well as to systems outside the data center), but some restrictions on the virtual machine may be implemented and additional logging may occur. Based on the restricted function and additional scrutiny, the cloud administrator may choose how long the virtual machine should remain in the un-trusted zone.

The disabled zone includes virtual machines exhibiting levels of suspicious activity exceeding an unacceptable threshold. The disabled zone houses virtual machines that are removed from network connectivity. Further, a snapshot of the state of a virtual machine in the disabled zone may be taken and stored for forensic analysis. In some cases, virtual machine snapshots may help to preserve evidence for possible legal prosecution purposes.

Depending on the activity, the relocated virtual machine may be the one engaging in observed suspicious activity. Alternatively, the relocated virtual machine may be the target of such suspicious activity. Or both the source and target of suspicious activity may be relocated, depending on the character of the suspicious activity. For example, assume virtual machine A is used to attack virtual machine B, residing on a common host. In such a case, A, or B, or both A and B may be relocated out of the trusted zone into an un-trusted or disabled zone.

Note, as described herein, “relocation” may refer to migrating a virtual machine from one pool of hosts to another pool. For example, a cloud hosting provider could provide a large number of physical servers for the “trusted zone,” and smaller pools of servers for the “untrusted” or “disabled” zones. In such a case, virtual machines may be relocated to servers in these pools when suspicious activity exceeds user specified thresholds. However, “relocation” may refer to simply changing an assigned state of the virtual machine. In such cases, when a virtual machine is reassigned from one zone to another, its configuration, access rights, or privileges may be changed to match a newly assigned zone. That is, a change in an assigned zone (e.g., from a trusted to an untrusted zone) may result in a change in assignment of capabilities, authorities, and/or services available to that virtual machine. For example, the network connectivity bandwidth allocated to virtual machine may be reduced (or eliminated) or some other form of sequestration could be applied to that virtual machine. Similarly, “relocation” could simply mean that additional logging processes are initiated for a virtual machine reassigned from one zone to another.

The security and relocation engine relocates virtual machines with suspicious activity levels which exceed defined thresholds. In one embodiment, a first threshold and a second threshold are defined. The first threshold is a warning threshold, and the second threshold is a higher, unacceptable threat threshold. Virtual machines with observed behavior exceeding the first threshold may be relocated to the un-trusted zone, where network connectivity may be limited and where additional logging may occur. Doing so may allow a provider to evaluate whether the relocated machine's activity is actually a threat to other machines in the provider's cloud. Further, over time, activity that triggered relocation to the un-trusted zone may grow stale. That is, certain activity may become less relevant or irrelevant over time, so that it is considered less suspicious or not suspicious.

Should a virtual machine engage in behavior exceeding the second threshold, then that virtual machine is essentially quarantined in the disabled zone. Note that some observed behavior may instantly cause a virtual machine to be relocated to the disabled zone. Note also that the threshold levels may be customized for different groups of virtual machines. For example, more sensitive or critical virtual machines may have lower threshold levels (i.e. easier to exceed), and vice versa.

In one embodiment, if the evaluation of a virtual machine results in a suspicious activity level that exceeds the warning threshold, but not the unacceptable threat threshold, the security and relocation engine relocates that virtual machine to an un-trusted zone. When this occurs, the security and relocation engine can notify an administrator. Similarly, the cloud provider may contact or otherwise notify the owner of a virtual machine to request information about the applications running on the virtual machine. In another embodiment, if a suspicious activity level exceeds the unacceptable threat threshold, then the security and relocation engine relocates the virtual machine to the disabled zone.

The security and relocation engine may also preserve data regarding false positives and, over time, learns to exclude such data from its calculations. As noted, the security and relocation engine may apply a time decay function that reviews instances of suspicious activity from its tally over time. Instances of suspicious activity that become less relevant over time are removed. In one embodiment, virtual machines may be relocated back to the trusted zone when their levels of suspicious activity fall below the first threshold. But the security and relocation engine will continue to evaluate virtual machines that are back in the trusted zone from the un-trusted or disabled zone.

In the following, reference is made to embodiments of the invention. However, the invention is not limited to specific described embodiments. Instead, any combination of the following features and elements, whether related to different embodiments or not, is contemplated to implement and practice the invention. Furthermore, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in one or more claims. Likewise, reference to “the invention” shall not be construed as a generalization of any inventive subject matter disclosed herein and shall not be considered to be an element or limitation of the appended claims except where explicitly recited in a claim(s).

Aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as an “engine,” “module” or “system.” Furthermore, aspects of the present invention may take the form of a computer program product embodied in one or more computer readable media having computer readable program code embodied thereon.

Any combination of one or more computer readable media may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples of a computer readable storage medium include: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the current context, a computer readable storage medium may be any tangible or otherwise non-transitory medium that can contain or store a program for use by or in connection with an instruction execution system, apparatus, or device.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment or portion of code that comprises one or more executable instructions for implementing the specified logical function(s). In some alternative implementations the functions noted in the block may occur out of the order noted in the figures. For example, two blocks shown in succession may, in fact, be executed substantially concurrently, or the blocks may sometimes be executed in the reverse order, depending upon the functionality involved. Each block of the block diagrams and/or flowchart illustrations, and combinations of blocks in the block diagrams and/or flowchart illustrations can be implemented by special-purpose hardware-based systems that perform the specified functions or acts, or combinations of special purpose hardware and computer instructions.

As noted, embodiments of the invention may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources. A user can access any of the resources that reside in the cloud at any time, and from anywhere across the Internet. Indeed, the virtual machine images and storage resources described here are located in a cloud computing network.

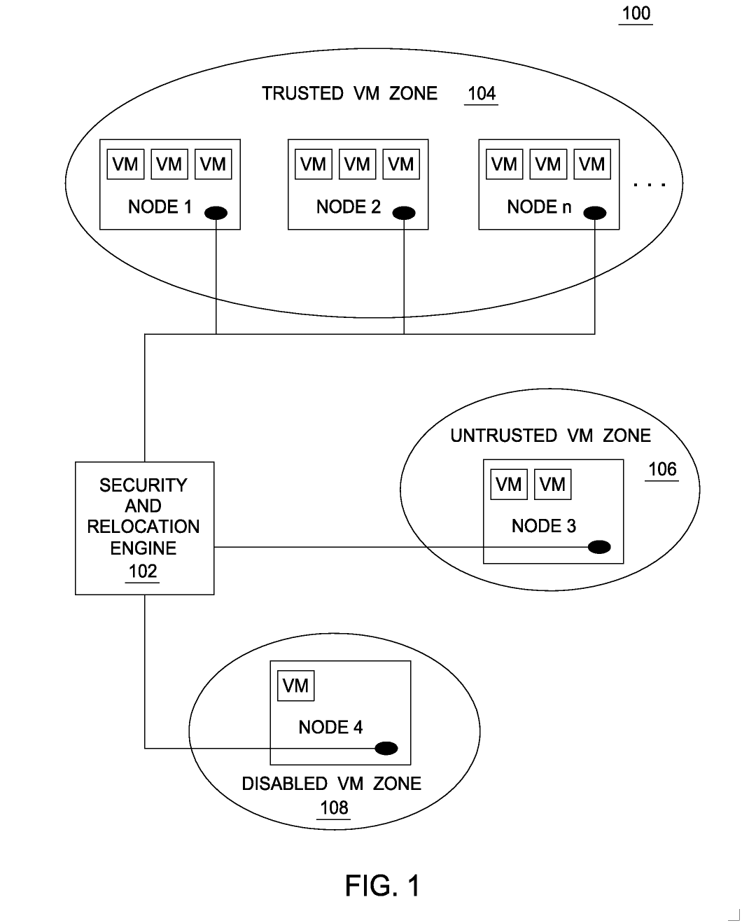

FIG. 1 illustrates a collection of nodes separated into security zones managed by a security and relocation engine, according to one embodiment. As shown, the cluster 100 includes a security and relocation engine 102 connected to three zones: a trusted virtual machine (VM) zone 104, an un-trusted VM zone 106, and a disabled VM zone 108. The trusted VM zone 104, the un-trusted VM zone 106, and the disabled zone 108 each contain one or more physical nodes, each of which may contain one or more virtual machines. Virtual machines in the trusted zone 104 experience typical service levels and typical monitoring levels as may be defined by their respective service level agreements or otherwise.

When a virtual machine in the trusted zone 104 is observed to exhibit levels of suspicious activity, the security and relocation engine 102 determines whether to relocate that virtual machine to the un-trusted zone 106 or the disabled zone 108, or to otherwise change in assignment of capabilities, authorities, and/or services available to that virtual machine based on a zone reassignment. For example, the security and relocation engine 102 may periodically evaluate metrics associated with or derived from the activity of each virtual machine and assign an overall activity score. If the assigned score exceeds a specified threshold, then the corresponding virtual machine may be relocated to an un-trusted zone. In one embodiment, virtual machines in the un-trusted zone 106 may experience diminished service levels and heightened monitoring and logging levels. In general, services available to the virtual machines in the un-trusted zone 106 are not limited, instead performance of the VMs may be downgraded because additional logging is enabled and the physical hardware may not be as powerful as the hardware used in the trusted zone 104.” In addition, on certain virtualized platforms, e.g., IBM Power® platform, resources, such as processing power, might be reduced. For example, a virtual machine may be running with 1.5 CPUs in the trusted zone 104, but when migrated to the un-trusted zone 106, it may be assigned 0.5 CPUs. Doing so allows for more virtual machines on less hardware, as well as frees processing power for machines in the trusted zone 104. Virtual machines in the disabled zone 108 may be disconnected from the network, essentially quarantining such virtual machines. Further, the provider may capture time-stamped snapshots of the virtual machine image for virtual machines in the disabled zone. Such snapshots may help with forensic analysis of the sources and causes of the suspicious activity, and also preserve evidence of malicious activity.

In another embodiment, certain instances of suspicious activity may not require scoring, e.g., a single instance of suspicious activity may suffice to justify relocating the virtual machine. That is, in addition to scoring metrics and determining whether the threshold has been exceed, the security and relocation engine may also apply rules to observed behavior. For example, if a virtual machine appears to be infected with a virus or malware, that virtual machine may be immediately relocated away from healthy virtual machines, without any activity scoring needed.

The security and relocation engine 102 relocates virtual machines from one of the three zones into another, based on whether the virtual machine exhibits certain levels of suspicious activity. Over time, as past suspicious activity becomes less relevant, the security and relocation engine 102 may relocate virtual machines from the un-trusted zone 106 or the disabled zone 108 back into the trusted zone 104. For example, suspicious activity such as IP address cloning or unacceptably high CPU utilization may become less relevant over time as those IP addresses become outdated, or the CPU utilization falls to acceptable levels.

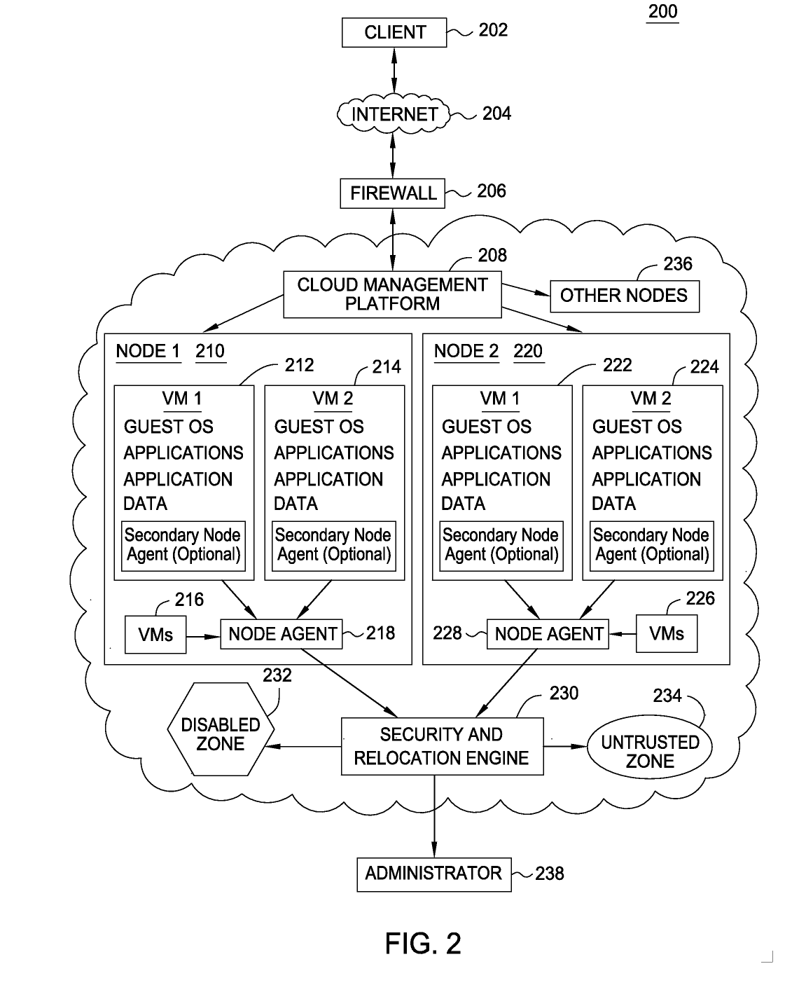

FIG. 2 illustrates an example cloud environment 200, according to one embodiment. As shown, the cloud environment is accessed by a client 202 via the Internet 204 through a firewall 206. Cloud management platform 208 manages various physical nodes hosting virtual machine instances on behalf of client 202. For example, the cloud management platform 208 may be used to deploy new virtual machine images on the nodes of a cloud provider, configure the network and storage connectivity of such images, or perform a variety of other management tasks. Illustratively, cloud management platform 208 is connected to physical nodes 210 and 220, as well as to other nodes 236. In one embodiment, node 210 includes two example virtual machines 212 and 214, plus other virtual machines 216, and a node agent 218.

Virtual machines 212 and 214 each host a guest operating system (OS), applications, and application data. Virtual machines 212 and 214 may also include an optional secondary node agent 225. Of course, virtual machine images may include a variety of additional components. The virtual machines 212, 214, and other virtual machines 216 connect to a node agent 218. Similarly, node 220 also includes example virtual machines 222 and 224 which, along with other virtual machines 226, also connect to a node agent 228. In another embodiment, the other nodes 236 have a similar configuration as nodes 210 and 212.

Node agents 218 and 228 transmit activity data to a security and relocation engine 230. In one embodiment, the security and relocation engine 230 uses the data to determine whether to relocate a virtual machine to either the un-trusted zone 234 or the disabled zone 232 or to otherwise change an assignment of capabilities, authorities, and/or services available to that virtual machine. In another embodiment, the security and relocation engine 230 also notifies the administrator 238 of virtual machines that have been relocated.

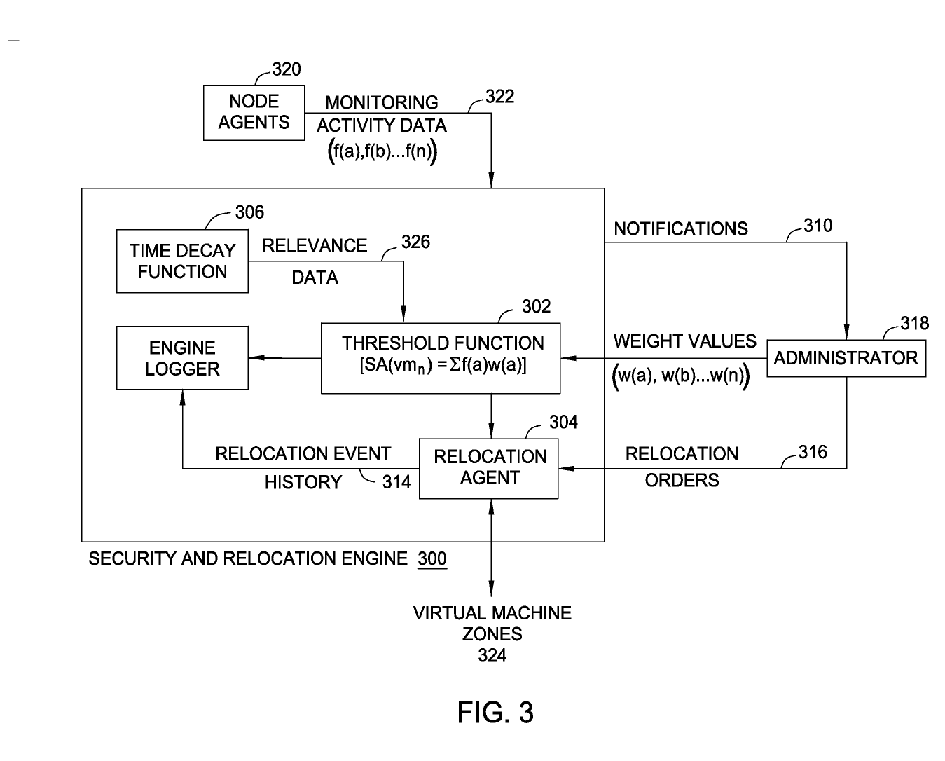

FIG. 3 illustrates an example security and relocation engine 300, according to one embodiment. As shown, the security and relocation engine 300 includes a threshold function 302, a relocation agent 304, a time decay function 306, and an engine logger 308. In one embodiment, the security and relocation engine 300 is separate from the virtual machine zones and receives monitoring activity data 322 sent from the node agents 320. Alternatively, the security and relocation engine 300 may query the node agents 320 to retrieve monitoring activity data 322. The threshold function 302 calculates the total measure of suspicious activity for each virtual machine, using the monitoring activity data 322. In one embodiment, the threshold function 302 determines a measure of suspicious activity for each virtual machine according to the following customizable equation:

SA(vwₙ)=Σ_{αA}f(α)w(α)

where

vmₙ is an example virtual machine;

SA is the determined total measure of suspicious activity for vmₙ;

α is a category of suspicious activity that is a member of the complete set of categories of suspicious activity A;

f(α) is the frequency of instances of suspicious activity α;

w(α) is the weight value applied to suspicious activity of type α; and

A is a discrete set of finite values based on the suspicious activity detected.

To determine the total measure of suspicious activity for a virtual machine vmₙ, the threshold function 302 first uses monitoring activity data 322 to determine f(α), i.e. the frequency of suspicious activity of type α. Then the threshold function 302 multiplies the frequency f(α) by a weight value w(α) provided by the administrator 318. In one embodiment, the security and relocation engine 300 saves previously provided weight values for future use, although the administrator 318 may adjust the weight value for any type of suspicious activity and provide updated values to the security and relocation engine 300. Finally, the threshold function 302 sums the f(α)w(α) products for each type of suspicious activity α over the set of types of suspicious activity A, to arrive at the total measure of suspicious activity SA for the virtual machine vmₙ.

The threshold function 302 compares the total measure of suspicious activity SA for a virtual machine with certain thresholds, to check if the security and relocation engine 300 should relocate the virtual machine. For example, if the threshold function 302 determines that SA for a given virtual machine is greater than a certain warning threshold, the security and relocation engine 300 may relocate the virtual machine to an un-trusted zone. Similarly, if the threshold function 302 determines that SA for a given virtual machine exceeds a higher, unacceptable threat threshold, the security and relocation engine 300 may relocate the virtual machine to a disabled zone.

If the security and relocation engine 300 observes that SA exceeds a certain threshold level, security and relocation engine 300 sends notifications 310 to the administrator 318. The relocation agent 304 acts on relocation orders 316 to move a virtual machine among various virtual machine zones 324.

In one embodiment, a time decay function 306 determines the relevance of the monitoring activity data 322. The time decay function 306 may, in one embodiment, determine that monitoring activity 322 from the previous hour or the previous day is no longer relevant to determining suspicious activity because the activity is no longer affecting the virtual machine. For example, monitoring activity data points like IP address thefts may become less relevant or irrelevant over time, as legitimate use of those IP addresses declines or ends in favor of other IP addresses. The time decay function provides its determinations to the security and relocation engine, in the form of relevance data 326. The security and relocation engine 300 can use relevance data 326 from the time decay function 306 to reduce false positives, making more intelligent relocation decisions. For example, if certain instances of suspicious activity α are less relevant or irrelevant for a particular virtual machine, the security and relocation engine 300 may choose to exclude those from the calculations of the threshold function 302. So the total measure of suspicious activity SA for that virtual machine will be lower. As a result, the security and relocation engine 300 may relocate the virtual machine only if SA comprises relevant instances of suspicious activity.

The engine logger 308 records the activity of the security and relocation engine 300. Using data such as type of monitoring activity received, the determinations of the threshold function 302, and whether the virtual machine was relocated, the engine logger generates relocation decision patterns. For example, the engine logger 308 may observe that whenever the threshold function 302 determines that a virtual machine's sustained CPU usage has exceeded 90%, the security and relocation engine 300 always receives relocation orders 316 from the administrator 318. The engine logger 308 may then generate a decision pattern for the security and relocation engine 300. The security and relocation engine 300 may apply the decision pattern to future instances where the security and relocation engine 300 observes a virtual machine's CPU usage exceeding 90%. At future instances of a virtual machine's CPU usage exceeding 90%, the security and relocation engine 300 may relocate the virtual machine without needing relocation orders 320 from the administrator 318. In one embodiment, the administrator 318 may customize variables such as the length of time or frequency of relocation events that would constitute a pattern in the determination of the engine logger 308.

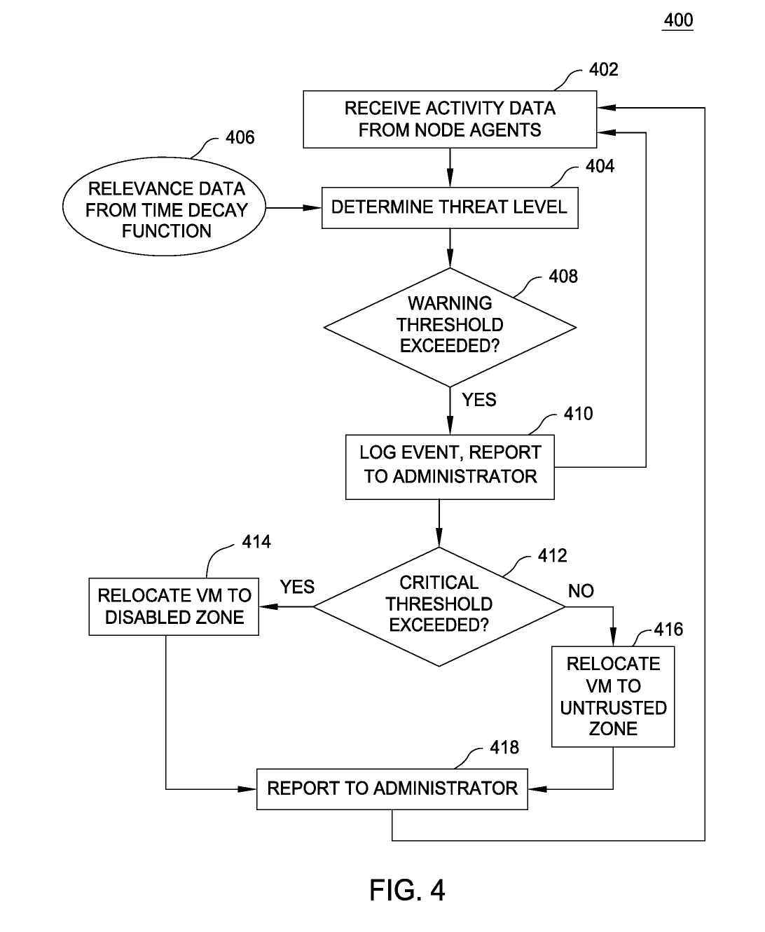

FIG. 4 illustrates a method 400 for determining whether to relocate a virtual machine based on observed activity of that machine, according to one embodiment. As shown, the method begins at step 402, where the security and relocation engine receives activity data from a node agent on a hypervisor running a given virtual machine. As noted, a node agent running on a virtual machine guest OS (i.e., in the application space of the virtual machine) may also provide information to the security and relocation engine. At step 404, the security and relocation engine determines a threat level, i.e. the level of suspicious activity exhibited by the virtual machine. At 406, the security and relocation engine determines whether the suspicious activity level has exceeded a first threshold.

If the activity level exceeds the first threshold, at step 408 the security and relocation engine logs the event and reports the event to the cloud administrator. At step 410, the security and relocation engine determines whether the suspicious activity level crosses a higher second threshold. If the higher second threshold is not exceeded, the security and relocation engine relocates the virtual machine to the un-trusted zone in step 412. If the higher second threshold is exceeded, the security and relocation engine relocates the virtual machine to the disabled zone in step 414. At step 416, the security and relocation engine logs the relocation event, and notifies the administrator that the security and relocation engine has relocated the virtual machine, including the virtual machine's name, destination, time of relocation, or any other relevant information. The security and relocation engine continues to monitor the virtual machine even after relocation.

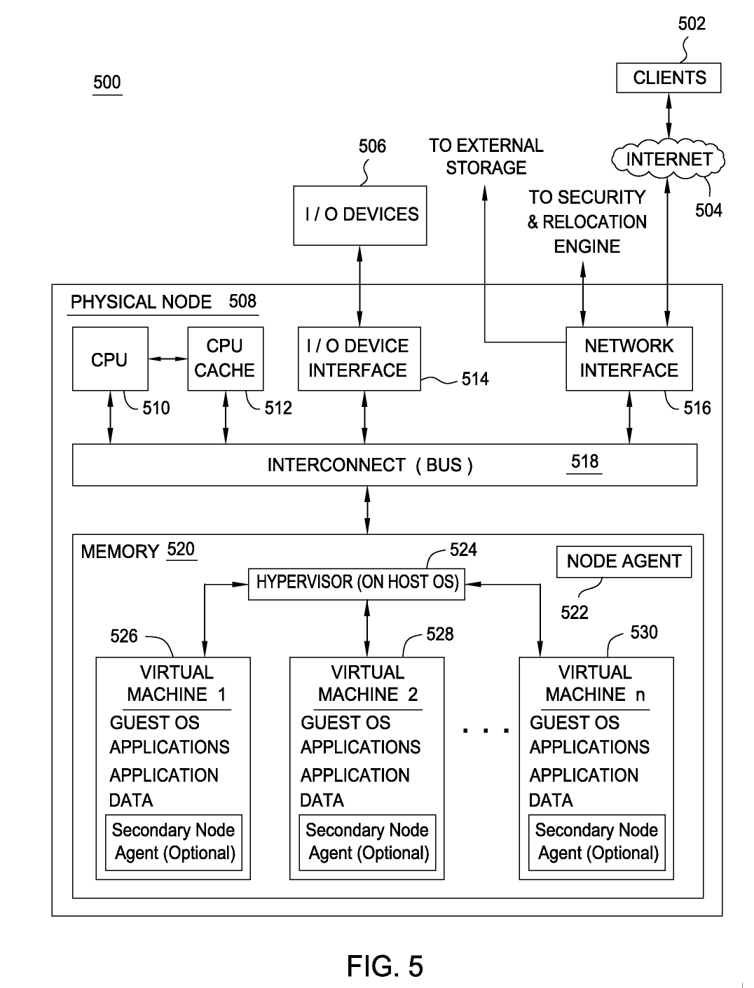

FIG. 5 illustrates an example virtual machine system 500 in the cloud, according to one embodiment. As shown, clients 502 connect via the internet 504 to a physical node 508 that houses one or more virtual machines. In one embodiment, the physical node 508 is connected via I/O devices 506 (such as keyboards and mice) to external storage and to the security and relocation engine. The physical node 508 includes, without limitation, a central processing unit (CPU) 510, a CPU cache 512, an I/O device interface 514, and a network interface 516, all connected to an interconnect (bus) card 518. The physical node 508 also includes memory 520, and the memory 520 includes the node agent 522, the hypervisor 524, and example virtual machines 526, 528, and 530.

In one embodiment, the virtual machines may include a guest operating system, applications, application data, and an optional secondary node agent 535 used to gather additional suspicious activity data. An actual virtual machine image may include a variety of additional components. The hypervisor 524 creates, runs, and controls the operation of each virtual machine residing in the physical node 508. The interconnect bus 518 transmits programming instructions and application data between the CPU 510, the CPU cache 512, the I/O device interface 514, the network interface 516, and memory 520. Memory 520 is generally included to be representative of a random access memory. The CPU 510 is included to be representative of a single CPU, multiple CPUs, a single CPU comprising multiple processing cores, and the like.

The node agent 522 residing in memory 520 collects activity data from each virtual machine. The node agent 522 transmits activity data via the interconnect bus 518 to the network interface 516. Optional secondary node agents 535 within a virtual machine may also transmit activity data via the interconnect bus 518 to the network interface 516. The network interface 516 transmits the suspicious activity data out of the physical node to the security and relocation engine 230, according to one embodiment.

The administrator may define certain types of suspicious activity, the weight value assigned to each type of suspicious activity, and thresholds used by the security and relocation engine to make relocation decisions. The suspicious activity levels and thresholds are customizable depending on the cloud environment and the specific virtual machines within the cloud environment. Having node agents embedded in each node enables suspicious activity tracking for each virtual machine. Given this data, the security and relocation engine may then relocate machines exhibiting high levels of suspicious activity to either an un-trusted zone or a disabled zone, or other zones as may be defined by the administrator.

Advantageously, embodiments presented herein provide techniques for virtual machine trust isolation within IaaS public, private, or hybrid cloud networks. Node agents provide real-time suspicious activity data tracking, enabling a cloud administrator to make timely relocation and isolation decisions about a particular virtual machine. This has the advantage of apprehending malicious conduct that may otherwise go undetected. By enabling virtual machine isolation into a disabled zone, the embodiments presented herein also enable an administrator to quarantine affected virtual machines so that damage from any malicious conduct does not spread to healthy virtual machines. The security and relocation engine may, in one embodiment, preserve data regarding false positives that will reduce relocation errors. A time decay function informs the security and relocation engine about less relevant (over time) suspicious activity data points. Relevance data about suspicious activity data enables the security and relocation engine to make more intelligent relocation decisions. Additionally, given defined suspicious activity types (and respective weights) and defined thresholds, the security and relocation engine may become fully automated and dynamically reassign the virtual machine to security zones without administrator intervention. In one embodiment, time-stamped snapshots are taken of machines in the disabled zone, enabling preservation of key forensic data for technical and legal investigation purposes.

While the foregoing is directed to embodiments of the present invention, other and further embodiments of the invention may be devised without departing from the basic scope thereof, and the scope thereof is determined by the claims that follow.

What is claimed is:

1. A method of enforcing virtual machine trust isolation in a cloud environment, the method comprising:
receiving activity data generated from monitoring a virtual machine with a zone assignment of a trusted zone in the cloud environment;
determining, from the activity data, a measure of suspicious activity engaged in by the virtual machine; and
reassigning the zone assignment of the virtual machine if the measure of suspicious activity exceeds a at least a first threshold.

2. The method of claim 1, wherein reassigning the zone assignment of the virtual machine includes relocating the virtual machine from a first host server to a second host server.

3. The method of claim 1, wherein a node agent on a hypervisor managing execution of the virtual machine transmits the activity data for the virtual machine to a security and relocation engine and wherein the security and relocation engine determines the measure of suspicious activity.

4. The method of claim 1, wherein determining the measure of suspicious activity engaged in by the virtual machine comprises:
measuring a frequency of occurrence each of one or more types of suspicious activity; and
summing a product of the frequency of occurrence each respective type of suspicious activity and associated an weight value for each type of suspicious activity for the virtual machine.

5. The method of claim 1, wherein reassigning the zone assignment of the virtual machine comprises:
determining that the measure of suspicious activity exceeds the first threshold; and
assigning the virtual machine to an un-trusted zone.

6. The method of claim 5, further comprising:
determining, based on the monitoring of the virtual machine while assigned to the un-trusted zone, an updated measure of suspicious activity engaged in by the virtual machine;
upon determining the updated measure of suspicious activity falls below the first threshold; and
reassigning the virtual machine to the trusted zone.

7. The method of claim 1, wherein reassigning the zone assignment of the virtual machine comprises:
determining that the measure of suspicious activity exceeds at least a second threshold; and
relocating the virtual machine to a disabled zone.
